(19) United States
(12) Patent Application Publication
(10) Pub. No.: US 2004/0071053 A1
(43) Pub. Date: Apr. 15, 2004

(54) Detecting device, detecting method, and optical disk device

(75) Inventor: Mikio Yamamuro, Ome-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/607,582

(22) Filed: Jun. 27, 2003

(30) Foreign Application Priority Data
Jun. 28, 2002 (JP) 2002-189947

(51) Int. Cl. G11B 7/095

(52) U.S. Cl. 369/44.29; 369/44.25; 369/44.41

(57) ABSTRACT

A detecting device includes an optical pickup which receives a first reference potential supplied thereto through a transmission line, sets the potential to a second reference potential affected by a noise component in the transmission line, generates detection signals from photodetector on the basis of the second reference potential, and outputs the detection signal and the second reference potential through the transmission line, and differential amplifiers which receive the detection signal and the second reference potential from the optical pickup through the transmission line to output potential difference between the detection signal and the second reference potential. The detecting device can remove the noise from a cable.

### CROSS-REFERENCE TO RELATED APPLICATIONS

This application is based upon and claims the benefit of priority from the prior Japanese Patent Application No. 2002-189947, filed Jun. 28, 2002, the entire contents of which are incorporated herein by reference.

### BACKGROUND OF THE INVENTION

1. Field of the Invention

The present invention relates to a detecting device and a detecting method for an optical disk, which includes an optical pickup and a signal processing portion, and an optical disk device utilizing the detecting device and the detecting method.

2. Description of the Related Art

In a conventional optical disk device, signal detection on an optical pickup and a reference potential in signal processing use a reference potential signal generated in a main portion of an optical disk drive. There often exit plural signals on the optical pickup, and all these signals use the same reference potential. The signal processing in the main portion is mainly performed with the reference potential generated in the main portion. Further, all the signals in which S/N might turn into problems are transmitted in a differential form. In the signal processing in the main port, the signal is received in the differential form and then converted mainly with the reference potential in the main port.

However, in this method, the main portion has a reference, the reference is transmitted to the optical pickup, the signal processed on the basis of the reference is solely transmitted to the main portion, and the signal is processed on the basis of the reference potential of the main portion. As a result, there is a problem that main portion can not correctly recognize the detection signal detected with the optical pickup, when difference between the reference potential on the optical pickup and the reference potential in the main portion is generated by effect of noise and the like.

Further, since plural signal lines are used, there is the problem that a noise component is amplified by affecting all the plural signal lines, when adding operation is performed in the main portion. Though these problems are removed when differential transmission is performed, on the other hand, two signal lines are required for each signal, and it can not be adopted for the case that constraints of a shape exist like the optical pickup. Even in the differential method, there is the problem that the noise mixed in transmitting the reference potential from the main portion can not be removed.

That is, in the conventional apparatus, when difference between reference potentials occurs by superimposing the noise and the like between the optical pickup and a main drive apparatus, there is the problem that the detection signal at the optical pickup can not be correctly obtained on the side of the main portion of the drive apparatus.

### BRIEF SUMMARY OF THE INVENTION

According to one aspect of the present invention, there is provided a detecting device comprises a transmission line, an optical pickup which connecting the transmission line and having a photo-detecting element, the optical pickup receives a first reference potential from a transmission line, sets the potential to a second reference potential affected by a noise component in the transmission line, generates a detection signal from the photo-detecting element on the basis of the second reference potential, and outputs the detection signal and the second reference potential through the transmission line, and a differential amplifier which receives the detection signal and the second reference potential from the optical pickup through the transmission line, and outputs potential difference between the detection signal and the second reference potential.

### BRIEF DESCRIPTION OF THE SEVERAL VIEWS OF THE DRAWING

FIG. 1 is a block diagram showing an example of an optical pickup detecting device according to an embodiment of the invention;

FIG. 2 is a block diagram showing another example of the optical pickup detecting device according to the embodiment of the invention; and

FIG. 3 is a block diagram of an optical disk device utilizing the optical pickup detecting device according to the embodiment of the invention.

### DETAILED DESCRIPTION OF THE INVENTION

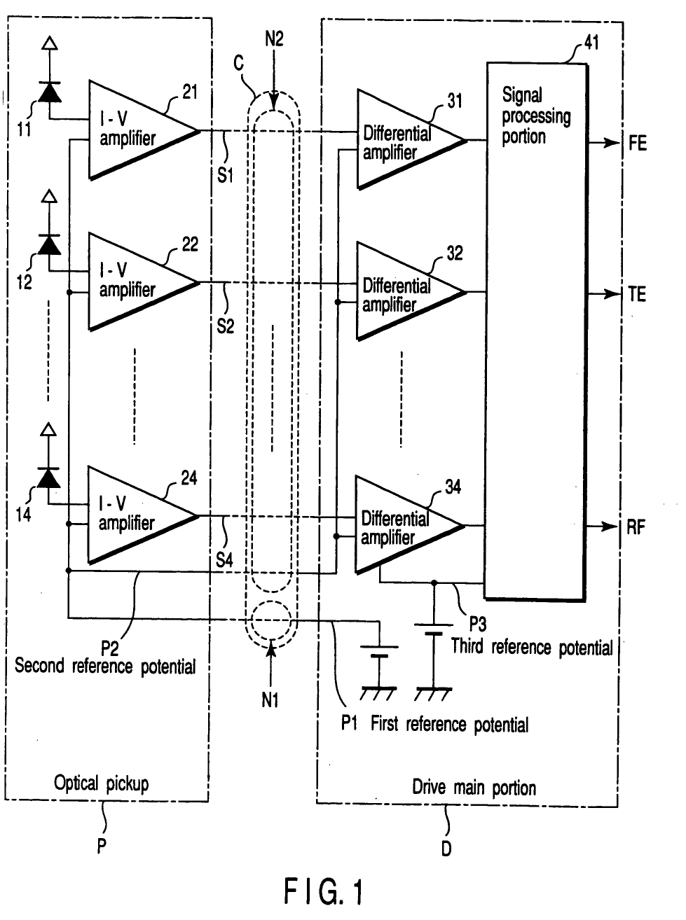

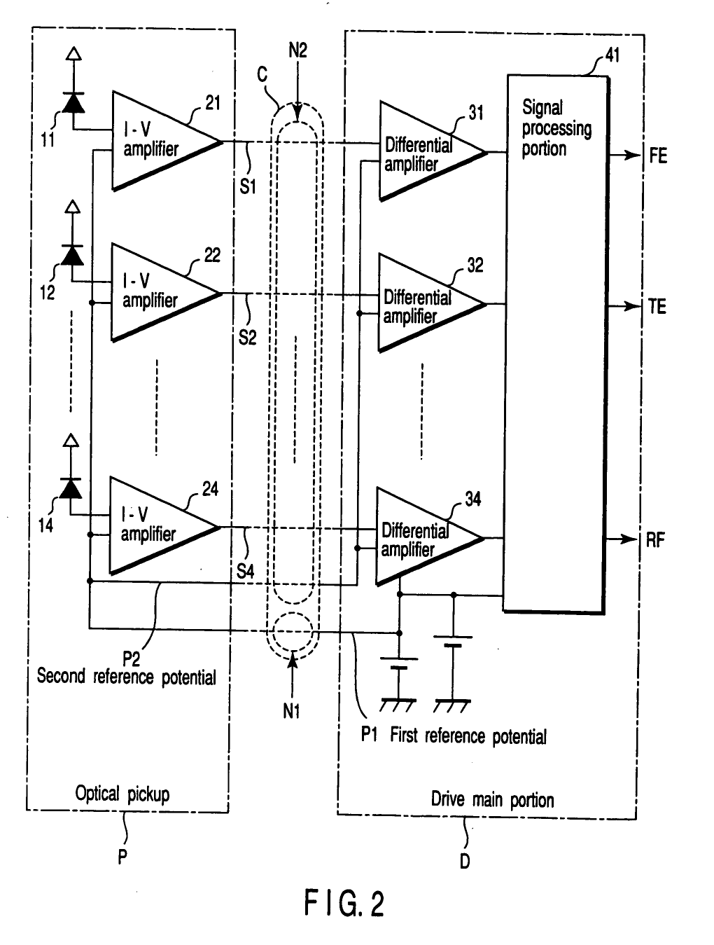

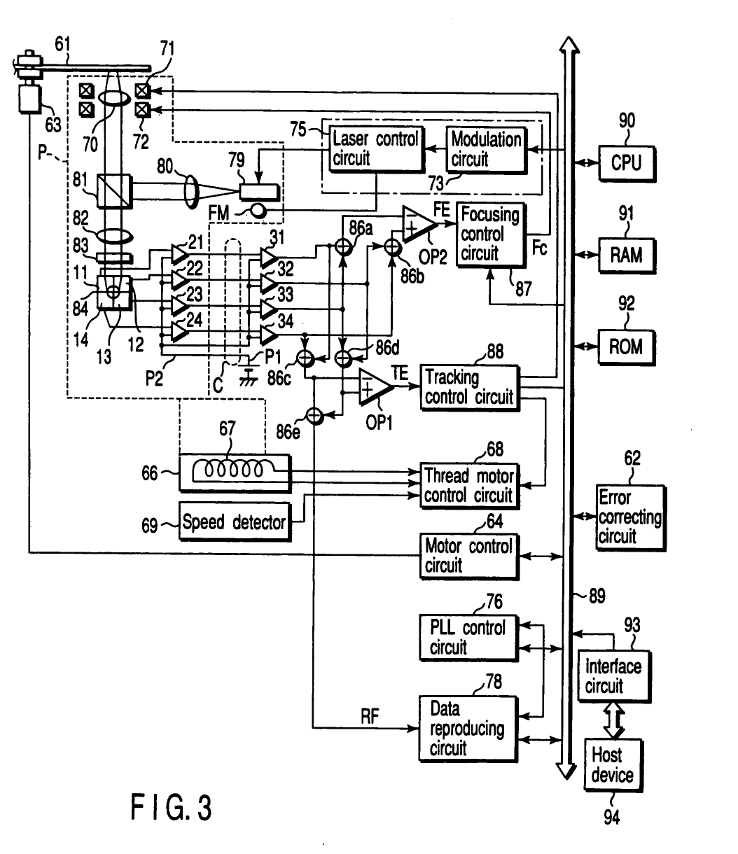

A detecting device and a detecting method and an optical disk device utilizing the detecting device and the detecting method will be described in detail below referring to the accompanying drawings. FIGS. 1 and 2 are block diagrams showing an example of an optical pickup detecting device according to an embodiment of the invention and FIG. 3 is a block diagram of the optical disk device utilizing the optical pickup detecting device according to the embodiment of the invention.

[Optical Pickup Detecting Device According to One Embodiment of the Invention]

The optical pickup detecting device according to the embodiment of the invention includes an optical pickup P and a drive main portion D. The optical pickup P is connected to the drive main portion D with a transmission line such as a cable C, and the optical pickup P and the drive main portion D are affected by constant noise components N1 and N2 according to disturbance. The optical pickup P includes plural photodetectors 11 to 14 and I-V amplifiers 21 to 24 which are connected to the photodetectors 11 to 14, respectively. A first reference potential P1 is supplied from the main portion D through the transmission line such as the cable C and shifted by superimposing of the noise component N1 to become a second reference potential. The I-V amplifiers 21 to 24 are operated by the reference potential which is treated as the second reference potential P2, and the detection signal is supplied from the photodetectors 11 to 14. The detected signal is subjected to I-V conversion and amplification processing by the I-V amplifiers 21 to 24, and supplied as detection signals S1 to S4 to differential amplifiers 31 to 34 in the main portion D through the transmission line such as the cable C. At the same time, the second reference potential P2 is also supplied to the differential amplifiers 31 to 34 in the main portion D, along with the detection signals S1 to S4.

These photodetectors 11 to 14 have various forms, e.g. a quad-cell detector, or an octa-cell detector in the case of a three-beam method, and the optical pickup P has the plural photodetectors such as four detectors or eight detectors according to the form.

The main portion D includes the differential amplifiers 31 to 34 corresponding to the number of signal lines, the differential amplifiers 31 to 34 are operated by a third reference potential P3 generated in the main portion D, and outputs of the differential amplifiers 31 to 34 are connected to a signal processing portion 41. At this point, it is preferable that the third reference potential P3 has the same potential as that of the first reference potential P1. For the detection signals S1 to S4 transmitted together with the second reference potential P2, the differential amplifiers 31 to 34 calculates the difference between each of the detection signals S1 to S4 and the second reference potential P2, and each calculated result is supplied to the signal processing portion 41.

As shown in FIG. 2, it is preferable that the third reference potential P3, which is the reference of the operation of the differential amplifiers 31 to 34 and the signal processing portion 41, is connected to the first reference potential P1. This allows the stable operation with high tolerance to the noise.

In a configuration of the optical disk device shown in FIG. 3, described later, the signal processing portion 41 includes at least a control circuit for focusing or tracking the pickup P, a laser control circuit, a control circuit for a spindle motor, an interface with external devices, and a control circuit for controlling those operations.

(Noise Reduction)

The noise components N1 and N2 superimposed on the cable C and the reference potential, which is a feature of the invention, will be described below.

When the first reference potential P1 is transmitted by the cable C and the like, the first reference potential P1 becomes the second reference potential P2 due to the superimposing of the noise component N1, and P2=P1+N1. Accordingly, values of the detection signals S1 to S4 of the I-V amplifiers 21 to 24 become S_{N}=K·I_{N}+P1+N1 (K is an I-V conversion factor). When the values are transmitted by the cable C and the like to reach the main portion D, the values become S′_{N}=K·I_{N}+P1+N1+N2 due to the further superimposing of the noise component N2. Further, when the value of the second reference potential is transmitted by the cable C and the like to reach the main portion D, the value of the second reference potential becomes P2′=P1+N1+N2 due to the further superimposing of the noise component N2. Since the differential amplifiers 31 to 34 calculate the difference between S′_{N} and P2′, i.e. (K·I_{N}+P1+N1+N2)-(P1+N1+N2) on the basis of the third reference potential P3, an output signal value K·I_{N}+P3 of the differential amplifier, in which the noise components N1 and N2 are eliminated, can be obtained.

At this point, it is worthy of note that the reference signal for the detection signals S1 to S4 is not always required to be supplied in pair to the main portion D and the noise can be removed during the transmission in a manner that exchanges the first reference potential P1 from the main portion D for at least the second reference potential P2 from the optical pickup P.

As described above, according to the invention, the first reference potential P1 is supplied from the main portion D, the detection signals S1 to S4 are generated by the second reference potential P2 including the noise component, and the difference between them is calculated by the differential amplifiers 31 to 34 by sending back the detection signals S1 to S4 with the second reference potential P2 including the noise component to the main portion D. As a result, the noise components N1 and N2 can be removed during the transmission with the cable C and the like, so that it is possible to provide the detecting device of the optical disk device, which can obtain the correctly detecting value.

[Optical Disk Device to Which the Invention is Applied]

FIG. 3 is a block diagram showing the configuration of an optical disk device to which the invention is applied. An optical disk 61 is an optical disk in which user's data can be recorded or a read-only optical disk. DVD-R, DVD-RAM, CD-R, and CD-RW may be cited as typical recordable optical disks.

A spiral-shaped land track and groove track are formed on a surface of the optical disk 61, and the optical disk 61 is rotationally driven with a spindle motor 63.

Recording/reproducing of information to the optical disk 61 is performed by the optical pickup P. The optical pickup P is coupled to a thread motor 66 through a gear, a tread motor control circuit 68 controls the thread motor 66.

A speed detecting circuit 69 is connected to the tread motor control circuit 68, and a speed signal of the optical pickup P, which is detected by the speed detecting circuit 69, is transmitted to the tread motor control circuit 68. A permanent magnet (not shown) is provided in a fixed portion of the thread motor 66, the optical pickup P is moved in a radial direction of the optical disk 61 in such a manner that the tread motor control circuit 68 excites a driving coil 67.

An objective lens 70 supported by a wire or a flat spring (not shown) is provided in the optical pickup P. The objective lens 70 can be driven by a driving coil 72 to be moved in a focusing direction (direction of an optical axis of the lens), and the objective lens 70 can driven by a driving coil 71 to be moved in a tracking direction (direction crossed at right angles with the optical axis of the lens).

A modulation circuit 73 performs eight to fourteen modulation (EFM) to user's data, which is supplied from a host device 94 through an interface circuit 93 during the recording, and provides EFM data. A laser control circuit 75 provides a signal for writing to a semi-conductor laser diode 79 on the basis of the EFM data supplied from the modulation circuit 73 during recording the information (forming a mark). The laser control circuit 75 also provides a signal for reading, which has smaller power than that of the signal for writing, to the semiconductor laser diode 79 during reading the information.

The semiconductor laser diode 79 generates a laser beam according to the signal supplied from the laser control circuit 75. The laser beam emitted from the semiconductor laser diode 79 is guided through a collimator lens 80, a half prism 81, and the objective lens 70, and the optical disk 61 is radiated with laser beam. Reflected light from the optical disk 61 is guided to a light detector 84 through the objective lens 70, the half prism 81, a condenser lens 82, and a cylindrical lens 83.

The light detector 84 includes the quad-cell photodetectors 11 to 14 shown in FIGS. 1 and 2. The output signals of the photodetectors 11 to 14 are given to the I-V amplifiers 21 to 24 which are the same as those shown in FIGS. 1 and 2.

At this point, the first reference potential P1 which is a feature of the invention, shown in FIGS. 1 and 2, becomes the second reference potential P2 by superimposing the noise component N1 through the cable C, and the second reference potential P2 is used as the reference potential of each of the I-V amplifiers 21 to 24. Further, the second reference potential P2 is supplied to each of the differential amplifiers 31 to 34 on the side of the main portion through the cable C.

In the same principle as the case shown in FIGS. 1 and 2, the noise components N1 and N2 given to the cable C are removed by function of the differential amplifiers 31 to 34. The outputs of the differential amplifiers 31 to 34 are supplied to differential amplifiers OP1 and OP2 through adders 86a to 86d.

The signal processing portion 41 shown in FIGS. 1 and 2 includes the adders 86a to 86d and the operational amplifiers OP1 and OP2, the operational amplifier OP2 supplies a focusing error signal FE to a focusing control circuit 87, the operational amplifier OP1 supplies a tracking error signal TE to a tracking control circuit 88, and the adders 86a to 86d supply an RF signal to a data reproducing circuit 78.

The differential amplifier OP2 outputs the focusing error signal FE according to the difference between the output signals of the adders 86a and 86b. The output is supplied to the focusing control circuit 87. The output signal (focusing control signal) of the focusing control circuit 87 is supplied to a focusing driving coil 72. This results in the control in which the laser beam is always just-focused on a recording film of the disk 61.

The differential amplifier OP1 outputs the tracking error signal TE according to the difference between the output signals of the adders 86c and 86d. The output is supplied to the tracking control circuit 88. The tracking control circuit 88 generates a track driving signal according to the tracking error signal from the differential amplifier OP1.

The track driving signal outputted from the tracking control circuit 88 is supplied to the driving coil 71. The tracking error signal used in the tracking control circuit 88 is supplied to the thread motor control circuit 68.

The performance of the focusing control and the tracking control affects a change in reflectivity, which is caused by a pit formed on the track of the optical disk 61 corresponding to the recording information, to the sum signal of the output signal of the photodetectors 11 to 14 in the light detector 86, i.e. the output sum signal RF of adder 86e adding both signals of the adders 86c and 86d. The signal is supplied to the data reproducing circuit 78.

The data reproducing circuit 78 reproduces the recording data on the basis of a clock signal for reproducing from a PLL circuit 76. The data reproducing circuit 78 has a function of measuring amplitude of the signal RF, and the measuring value is read with a CPU 90.

When the objective lens 70 is controlled by the tracking control circuit 88, the thread motor control circuit 68 controls the thread motor 66, i.e. the optical pickup P such that the objective lens 70 is located near the central position of the optical pickup 5.

The motor control circuit 64, the thread motor control circuit 68, the modulation circuit 73, the laser control circuit 75, the PLL circuit 76, the data reproducing circuit 78, the focusing control circuit 87, the tracking control circuit 88, and the like can be formed within one LSI chip as a servo control circuit, and these circuits are controlled by the CPU 90 through a bass 89. The CPU 90 comprehensively controls the optical disk device in accordance with an operation command provided from the host device 94. The CPU 90 uses a RAM 91 as a working area, and performs the predetermined operation in accordance with programs including the invention, which are recorded in a ROM 92.

In the optical disk device shown in FIG. 3, the embodiment of quad-cell photodetectors 11 to 14 was described, the deference between the four detection signals of the photodetectors 11 to 14 and the second reference potential P2 is determined by the differential amplifiers 31 to 34 in the same way as the case shown in FIGS. 1 and 2. Consequently, since the noised superimposed by the cable C can be removed, it is possible to perform the detection of the optical pickup with high reliability and high tolerance to the noise.

Those skilled in the art can realize the invention by the various embodiments described above, and it is easy for those skilled in the art to think of various kinds of modifications of the embodiments and to apply the invention to various modes without any inventive ability. Accordingly, the invention covers a wide range consistent to the disclosed principle and the novel feature and is not limited to the above-described embodiment.

For example, the example of the detecting device including the optical pickup and the signal processing portion processing the detection signal and the example of the optical apparatus utilizing the detector were described in the above-described embodiments, however, the invention is not limited to these embodiments. Any detecting device having the sensor portion and the signal processing portion processing the detection signal can be applied in the same principle and has the same effect and advantage.

As described in detail above, according to the invention, the difference of the reference potential between the sensor portion and the processing portion is reduced and the noise component is removed by the differential amplifier. This provides the detecting device and the detecting method, which can obtain the detection signal hardly receiving influence of the noise, and the optical disk device utilizing the detecting device and the detecting method.

What is claimed is:

1. A detecting device comprising:
a transmission line:
an optical pickup which connecting the transmission line and having a photo-detecting element, the optical pickup receives a first reference potential from a transmission line, sets the potential to a second reference potential affected by a noise component in the transmission line, generates a detection signal from the photo-detecting element on the basis of the second reference potential, and outputs the detection signal and the second reference potential through the transmission line; and
a differential amplifier which receives the detection signal and the second reference potential from the optical pickup through the transmission line, and outputs potential difference between the detection signal and the second reference potential.

2. A detecting device according to claim 1, wherein the differential amplifier is operated on the basis of a third reference potential having the same potential as that of the first reference potential.

3. A detecting device according to claim 1, wherein the differential amplifier is operated on the basis of a third reference potential connected to the first reference potential.

4. A detecting device according to claim 1, wherein the differential amplifier has a main portion which generates the first reference potential.

5. A detecting method comprising:
supplying a first reference potential through a transmission line;
setting the potential to a second reference potential affected by a noise component in the transmission line;
generating a detection signal from a photo-detecting element on the basis of the second reference potential;
outputting the detection signal and the second reference potential through the transmission line;
receiving the detection signal and the second reference potential from the optical pickup through the transmission line; and
outputting potential difference between the detection signal and the second reference potential with a differential amplifier.

6. A detecting method according to claim 5, wherein the differential amplifier is operated on the basis of a third reference potential having the same potential as that of the first reference potential.

7. A detecting method according to claim 5, wherein the differential amplifier is operated on the basis of a third reference potential connected to the first reference potential.

8. A detecting method according to claim 5, wherein the differential amplifier has a main portion which generates the first reference potential.

9. An optical disk device comprising:
a transmission line:
an optical pickup which connecting the transmission line and having a photo-detecting element, the optical pickup receives a first reference potential from a transmission line, sets the potential to a second reference potential affected by a noise component in the transmission line, radiates an optical disk with a laser beam to receive the reflected light by a photo-detecting element, generates a detection signal from the photo-detecting element on the basis of the second reference potential, and outputs the detection signal and the second reference potential through the transmission line;
a differential amplifier which receives the detection signal and the second reference potential from the optical pickup through the transmission line, and outputs potential difference between the detection signal and the second reference potential;
a focusing control circuit which generates a focusing control signal for moving an objective lens, which condenses the laser beam on the optical disk, in a direction of an optical axis on the basis of an output from the differential amplifier; and
a tracking control circuit which generates a track driving signal for moving the objective lens in a direction crossed at right angles with the optical axis on the basis of the output from the differential amplifier.

10. An optical disk device according to claim 9, wherein the differential amplifier is operated on the basis of a third reference potential having the same potential as that of the first reference potential.

11. An optical disk device according to claim 9, wherein the differential amplifier is operated on the basis of a third reference potential connected to the first reference potential.

12. An optical disk device according to claim 9, wherein the differential amplifier has a main portion which generates the first reference potential.
